(19) United States
(12) Patent Application Publication
(10) Pub. No.: US 2018/0172615 A1
(43) Pub. Date: Jun. 21, 2018

(54) Measuring Device for Determining Physical Properties, Chemical Properties, Biological Properties and/or Materials in the Surroundings of at Least One Sensor or of the at Least One Sensor as a Component of the Measuring Device

(71) Applicant: Sentronic GmbH Gesellschaft für Optische Messsysteme, Dresden (DE)

(72) Inventor: Matthias Lau, Dresden (DE)

(21) Appl. No.: 15/735,208

(22) PCT Filed: Jun. 13, 2016
(86) PCT No.: PCT/EP2016/063473

§ 371 Date: Dec. 11, 2017

(30) Foreign Application Priority Data
Jun. 15, 2015 (DE) 10 2015 210 880.5

(51) Int. Cl. G01N 27/30

(52) U.S. Cl. CPC G01N 27/302; G01K 1/024

(57) ABSTRACT

The invention relates to measuring devices for determining physical properties, chemical properties, biological properties and/or substances in the environment of at least one transducer or of the at least one transducer itself as a component of the particular measuring device. The measuring devices are in particular characterised in that they are simple and robust to control and their function can be influenced. For this purpose, the measuring device consists of at least one transducer as a component of a passive device and/or as a component of an active measuring functional unit. The active measuring functional unit further consists of a data-processing system and a transceiver unit for electromagnetic radiation, and is interconnected to an electric power source. Furthermore, the transceiver unit of the active measuring functional unit is wirelessly connected to at least one transceiver unit, for electromagnetic radiation, of at least one passive device that
comprises at least one operating element,
comprises at least one switch,
is designed for controlling the measuring device,
is designed for signalling,
is designed for obtaining measured values,
is designed for displaying an operating state,
is designed for calibrating the transducer,
is formed as a data medium, and/or
is formed as a data store.

### CROSS REFERENCE TO RELATED APPLICATIONS

This application is the U.S. national stage of International Application No. PCT/EP2016/063473, filed on 2016 Jun. 13. The international application claims the priority of DE 102015210880.5 filed on 2015 Jun. 15; all applications are incorporated by reference herein in their entirety.

### BACKGROUND

The invention relates to measuring devices for determining physical properties, chemical properties, biological properties and/or substances in the environment of at least one transducer or of the at least one transducer itself as a component of the particular measuring device.

Technical systems require power and generally also have corresponding interfaces for exchanging information. For the purpose of communication, radio links using electromagnetic radiation or conductors in the form of optical waveguides or electrical conductors are used. Power is usually supplied via electrical cables, integrated power sources or decentral power sources.

Electrical or optical connectors are usually very prone to faults under harsh environmental conditions, such as in sewage plants, fish-farming plants, when mining, or in plants prone to explosion, and are expensive. Inserting such connectors or protecting open connectors under harsh environmental conditions of this type is complicated and likely to incur faults, for example at low temperatures or on very rocky sea-based fish-farming plants.

Specific transducers, such as electrodes, become worn and have to be replaced intermittently. Such electrodes can be connected to the active measuring functional unit. The signal strengths are low and are thus already very prone to interference in the event of poor transmission. Electrical connectors are prone to faults and/or are expensive, and cannot be safely handled under dirty and/or moist conditions. EP 1 206 012 B1 discloses alternatives. One disadvantage of said alternatives is that extensive communication between the passive device including the transducer, formed as a pH electrode in this case, and the active measuring functional unit is not provided, since sufficient bidirectional data processing is not provided on the passive device. The simultaneous use of more than one passive device and/or the combination of more than one transducer on the passive and/or the active measuring functional unit is not provided.

DE 10 2011 005 807 A9 discloses a cuvette and an optical measuring apparatus. The cuvette comprises an information transmitter for wirelessly sending data relating to the cuvette, which are to be transmitted, to an external data-receiving module, the information transmitter being fixed to the cuvette wall. The cuvette can also be a component of an optical measuring device here. The data relating to the cuvette are wirelessly transmitted to a receiver.

DE 10 2011 005 807 A9 discloses a cuvette and an optical measuring device that comprises the cuvette. Said cuvette is in particular a sample cell for an apparatus for measuring a temperature-dependent, optical parameter of a fluid sample in a polarimeter. The cuvette comprises an information sensor for wirelessly providing data relating to the cuvette, the information sensor being formed as an active or a passive information sensor. In this case, specific, optically obtained measured data, temperature data and data that define the cuvette, for example in the form of calibration data or geometry data, can be transmitted. The cuvette and the optical measuring device are limited to recording data and transmitting them to a data-receiving module.

US 2014/0 218 718 A1 contains an analytical system for substances that are exposed to electromagnetic radiation for that purpose. The electromagnetic radiation received reaches detectors that can communicate with a data network in order to transmit the measured data. This relates to a photometric/spectrometric measuring method. Wireless transmission of data and power is not provided.

US 2014/0 211 204 A1 discloses a sensor module, which comprises an active power supply, sensory components and a radio link that is known from the field of communication technology. Furthermore, US 2010/0 110 439 A1 includes an optical measuring instrument, which can comprise an active power supply, the sensory components and a classic radio link in addition to wired communication. These solutions do not relate to passive components. Communication and the provision of power are carried out via separate paths.

DE 10 2012 014 503 A1 discloses a gas-measuring system for measuring the concentration of gaseous and/or vaporous components of a gas mixture by means of a change in colour of at least one reagent. The change in colour is detected and can be read out by means of a reader for an electronic data store using the measured data. For this purpose, the data store can be a component of a known RFID chip, which can be read out by means of alternating magnetic fields or radio waves.

WO 2010/085 736 A1 discloses a chlorophyll and turbidity sensor system. The system is wirelessly connected to a data receiver in order to communicate the measured data. Said receiver is also coupled to a display unit and/or a control unit.

### SUMMARY

The invention relates to measuring devices for determining physical properties, chemical properties, biological properties and/or substances in the environment of at least one transducer or of the at least one transducer itself as a component of the particular measuring device. The measuring devices are in particular characterised in that they are simple and robust to control and their function can be influenced. For this purpose, the measuring device consists of at least one transducer as a component of a passive device and/or as a component of an active measuring functional unit. The active measuring functional unit further consists of a data-processing system and a transceiver unit for electromagnetic radiation, and is interconnected to an electric power source. Furthermore, the transceiver unit of the active measuring functional unit is wirelessly connected to at least one transceiver unit, for electromagnetic radiation, of at least one passive device that
comprises at least one operating element,
comprises at least one switch,
is designed for controlling the measuring device,
is designed for signalling,
is designed for obtaining measured values,
is designed for displaying an operating state,
is designed for calibrating the transducer,
is formed as a data medium, and/or
is formed as a data store.

### DETAILED DESCRIPTION

The object of the invention specified in claim 1 is that of controlling a measuring device in a simple manner or influencing its function.

This object is achieved by the features set out in claim 1.

The measuring devices for determining physical properties, chemical properties, biological properties and/or substances in the environment of at least one transducer or of the at least one transducer itself as a component of the particular measuring device are characterised in particular in that they can be easily controlled and their function can be influenced.

For this purpose, the measuring device comprises an active measuring functional unit, at least one passive device that therefore does not comprise a power source, and at least one transducer, wherein the at least one transducer can be part of the measuring functional unit and/or part of the passive device.

The active measuring functional unit further comprises at least one data-processing system and one transceiver unit for electromagnetic radiation and is connected to an electrical power source.

Furthermore, the transceiver unit of the measuring functional unit is wirelessly connected to at least one transceiver unit, for electromagnetic radiation, of at least one passive device that
comprises at least one operating element in conjunction with at least one switch as a component of an electrical circuit,
is designed for controlling the measuring device,
is designed for signalling,
is designed for displaying an operating state,
is designed for transferring measured and/or reference values,
is designed for calibrating specific transducers,
is formed as a data medium, and/or
is formed as a data store.

The electromagnetic radiation, also known as electromagnetic waves, is electromagnetic radiation that transmits power and either signals and/or data such that the at least one passive device in conjunction with the measuring functional unit and at least one transducer forms the measuring device.

The active measuring functional unit forms an active sensor together with the at least one transducer, which can be targetedly and specifically influenced and/or brought to provide (user) feedback by means of the passive device.

The measuring functional unit provides the active part of the measuring device and can be mobile.

The passive unit, together with the at least one transducer, forms a passive sensor that targetedly and specifically influences the active measuring functional unit and/or is influenced by the active measuring functional unit.

The passive device is a self-contained system, which can be integrated in a fully contained housing. It is preferable for said housing to comply with IP67/IP68, to be chemically and/or biochemically resistant, to be non-toxic and to be non-carcinogenic. It can thus also be used under harsh environmental conditions, such as damp environments. Furthermore, depending on the intended use, said passive device can be designed so as to have a wide range of uses. This can be for identification purposes, as a measuring and/or control unit or as a status indication. The passive device can also be used on its own or in combination with at least one additional passive device at the same time and/or in parallel. Electrical supply lines and contacts are not required for it to function.

The passive device can be simply configured or programmed by a device provided externally thereto or by the measuring functional unit itself via the transceiver unit of the passive device.

The pulses, signals, data and/or programs in the form of software sent by the passive device influence the data-processing system of the measuring functional unit accordingly. These are in particular identified for this purpose and can be stored, forwarded, processed and/or executed.

The passive device can contain an electrical power store in the form of a temporary store, so that a fluctuating supply of power via the wireless transmission of power and/or a fluctuating consumption of power can be compensated for. Capacitors can be used as the temporary store. Furthermore, the passive unit can compensate for a fluctuating or insufficient consumption of power by means of additional wireless transmissions of power by photometric, thermal or acoustic energy converters, for example.

The at least one transceiver unit in the measuring functional unit and in the passive device comprises at least one antenna or coil to ensure electromagnetic coupling (power, signal and/or data transmission) between the at least one active measuring functional unit and the at least one passive device in each case. In order to allow these to function at the same time, more than one antenna or coil can also be used in different positions. These are preferably then connected in series. This is, for example, used when a passive device having a sensitive layer/diaphragm (for example a fluorescence layer) is integrated in a replaceable measuring cap, for example, which is fixed on the housing of an active measuring device for coupling/use purposes, and a calibration cuvette in the form of a passive device, for example, is intended to be used in parallel and/or at the same time, the geometric or functional construction of which does not allow the first antenna or coil to be used.

Furthermore, the at least one active measuring functional unit and the at least one passive device are preferably electromagnetically coupled in the near field in order to prevent cross-talking of the coupling when more than one coupling point is used in parallel and/or at the same time. Near-field communication preferably takes place at a frequency of 13.56 MHz and a maximum data transmission rate of 424 kBits/s. Communication is preferably cryptographically secured.

When an active measuring functional unit and a passive device are coupled, they generate a high-frequency magnetic field (electromagnetic field) between the loosely coupled antennae or coils both in the active measuring functional unit and in the passive device. As soon as the field is created, a connection is established, preferably by the active measuring functional unit, and information can be exchanged.

The passive measuring unit comprising a transceiver unit for electromagnetic radiation can be a separate measuring unit or can be designed in accordance with the passive device.

Advantageous embodiments of the invention are specified in claims 2 to 15.

According to the embodiment of claim 2, the electrical power source for the measuring functional unit in conjunction with the data-processing system and the transceiver unit is electric mains, an accumulator, a power converter or a combination thereof. A power converter is in particular a known wind turbine, wave power station, hydroelectric power station, thermal power station, acoustic energy plant, tidal power station or solar power system, all of which convert the particular energy into electrical energy.

According to the embodiment of claim 3, the transducer is an electrochemical sensor, a biochemical sensor, an optical sensor, a semiconductor sensor, a solids sensor, a microsystem, an electrode, an optrode, a physical sensor element or a combination thereof.

According to the embodiment of claim 4, the passive device comprises a data-processing system that is connected to the operating element, the switch, the signalling system, the display, the data medium, the data store, a measured value transducer and a measuring transmitter depending on its function.

The data-processing system is therefore a component of a control device. For this purpose, the data-processing system can be configured, can contain corresponding software, so that at least one specific function can be triggered. This can be calibrating the transducer, for example, wherein corresponding reference conditions are provided and the measured value from the transducer is made to correlate with the reference value by means of specific and/or defined processes/sequences, which changes the current property of the transducer.

According to the embodiment of claim 5, the passive device for calibrating the transducer is a calibration cuvette, which provides the reference conditions, triggers the calibration function and advantageously provides status messages, either continuously or at the end of the function.

According to the embodiment of claim 6, the calibration cuvette in the form of a passive sensor advantageously comprises at least one pressure sensor, one temperature sensor, one pH sensor, one conductivity sensor and/or one moisture sensor in each case. In addition to the reference conditions, for example the oxygen concentration in the case of an oxygen sensor, environmental conditions that are determined by the pressure sensor, the temperature sensor, the pH sensor, the conductivity sensor and/or the moisture sensor, for example, can also be detected and transmitted to an active measuring functional unit.

According to the embodiment of claim 7, the passive device comprising the switch is a starting or ending switch in conjunction with the transducer by means of the data-processing system of the active measuring functional unit. The passive device can have switching functions, which can be triggered in the active measuring functional unit. Activation can either be automatic in accordance with a radio link (coupling) of the passive unit to the measuring functional unit or can be carried out at the passive unit as a result of user interaction.

According to the embodiment of claim 8, the passive device in the form of a data store is a passive device containing data in the form of times, identification data, codes, actual values, reference values, software, a mathematical function, linearisation parameters, calibration parameters and/or an algorithm for influencing the data-processing system of the active measuring functional unit.

According to the embodiment of claim 9, the calibration cuvette in the form of a passive device is connected to the active measuring functional unit and to at least one transducer (active sensor) such that at least two reference values are passed to the transducer, preferably subsequently or following user interaction. The transducer thus provides at least one two-point calibration and/or determines reference conditions.

According to the embodiment of claim 10, the data-processing systems of the measuring functional unit and of the passive device are connected to one another by means of the respective transceiver units in order to transmit signals and/or data so as to influence the mode of operation of the particular data-processing system. Programs and data can thus be exchanged and executed accordingly. These are in particular the measured data obtained by the transducer, commands or configurations.

According to the embodiment of claim 11, the passive device for signalling is a passive device that emits at least one optical and/or at least one acoustic signal. Therefore, in particular the operating state and the operational readiness of or success messages from the measuring device or parts thereof can be displayed. This can also be done using threshold values, such that specific operating states determined by the threshold values can be signalled.

According to the embodiment of claim 12, the operating element of the passive device is at least one key and/or at least one switch in conjunction with a data-processing system of said passive device. Specific functions in conjunction with the active sensor can therefore be triggered.

According to the embodiment of claim 13, the passive device comprises at least one sensor element, wherein the passive device is a passive device comprising the at least one sensor element or wherein the sensor element is connected to the data-processing system of the passive device. The sensor element can be a temperature sensor, a pressure sensor, a moisture sensor, a pH sensor, a conductivity sensor, a gas sensor, an electrochemical sensor, a biochemical sensor or an optical sensor, or an electrode, optrode or physical sensor element.

Specific operating modes determine the measured values in the data-processing system on the basis of the sensor element(s) and then transmit them either actively or upon request to an active measuring functional unit.

These data can then be recorded, stored, processed and/or transmitted using corresponding algorithms, for example in an FPGA or a software/firmware of the data-processing system of the measuring functional unit.

The passive device in the form of a passive sensor comprises at least one sensor/measured value transducer of its own and the measured values thereof are transferred via the respective transceiver units by the active measuring functional unit or the measuring device. Therefore, the range of functions of the measuring device can temporarily or continuously be changed. This can be done for compensation purposes, for example. Therefore, a sensor for measuring gases in the atmosphere or gases dissolved in liquids, for example, can be expanded by a pressure sensor for use at different altitudes or depths. This can be done for referencing purposes. Therefore, when calibrating oxygen sensors or carbon dioxide sensors, for example, a barometric pressure sensor can measure the ambient pressure required and send it to the active sensor (measuring functional unit plus at least one transducer), or a gas sensor can measure the present gas concentration and transmit it to the active measuring functional unit. For example, a pH electrode forming part of the passive device can therefore also determine the pH value and transmit it to the active measuring functional unit without electrical contact elements and in a galvanically separated manner. This can also be carried out, for example, in order to determine complex sum parameters. Therefore, a sensor for measuring dissolved oxygen can be expanded for use in salt water by the function of the conductivity sensor in order to determine the salinity. If said sensor is used in drinking water again, the passive device can be removed.

According to the embodiment of claim 14, the transceiver unit for electromagnetic radiation and the active measuring functional unit are releasably connected. Furthermore, the transceiver unit is interconnected to the active measuring functional unit and to the electrical power source. For this purpose, the transceiver unit can advantageously be formed as a cap that can be screwed on by means of a screw connection or slid on by means of a clamping connection.

According to the embodiment of claim 15, the transceiver unit for electromagnetic radiation, which unit can be connected to the active measuring functional unit, is connected to a data medium, a data store and/or an additional data-processing system. Therefore, data from the data-processing system of the active sensor can be transmitted as usage information either cyclically or according to specific processes, such as a calibration. The user can connect the cap to a different active sensor so that usage data are automatically transmitted to the data-processing system of the other active sensor.

An embodiment of the invention is shown schematically in each of the drawings, and will be described in more detail in the following.

### BRIEF DESCRIPTION OF THE DRAWINGS

In the drawings:

FIG. 1 shows a measuring device comprising an active measuring functional unit and a passive device in the form of a cuvette,

FIG. 2 shows a measuring device comprising an active measuring functional unit in a passive device in the form of a cuvette,

FIG. 3 shows a measuring device comprising an active measuring functional unit and a passive device for controlling the measuring device,

FIG. 4 shows a passive device in the form of an information means, and

FIG. 5 shows a passive device comprising a transducer, which is mounted on an active measuring functional unit.

### DETAILED DESCRIPTION OF THE PREFERRED EMBODIMENTS

The measuring devices for determining physical properties, chemical properties, biological properties and/or substances in the environment of at least one transducer or of the at least one transducer itself as a component of the particular measuring device substantially consists of the transducer, the at least one active measuring functional unit together with its data-processing system, its connection to at least one transceiver unit for electromagnetic radiation, its electrical power source, and at least one passive device, which comprises a transceiver unit for electromagnetic radiation and
comprises at least one operating element in conjunction with at least one switch as a component of an electrical circuit,
comprises at least one switch as a component of an electrical circuit,
is designed for controlling the measuring device,
is designed for signalling,
is designed for displaying an operating state,
is designed for transmitting measured and/or reference values,
is designed for calibrating the transducer,
is formed as a data medium, and/or
is formed as a data store.

In this case, the electromagnetic radiation is electromagnetic radiation that transmits power and either signals and/or data, preferably in the near field (NFC), such that the passive device forms a measuring device together with the active measuring functional unit and the transducer.

In a first embodiment, the passive device can be a calibration cuvette.

In this regard,

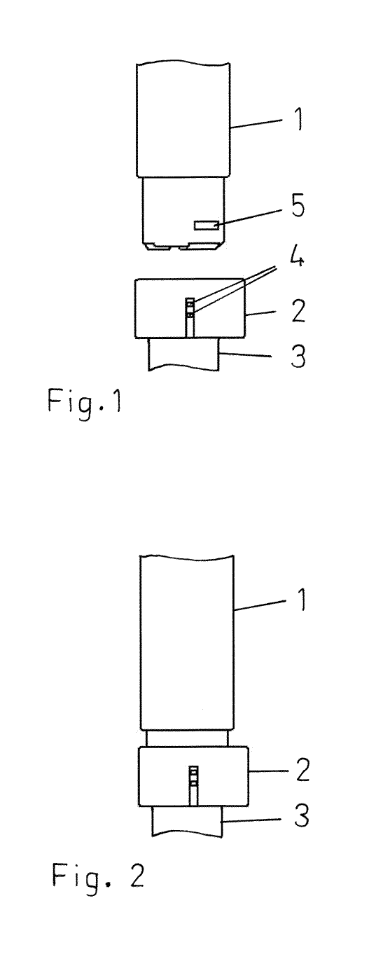

FIG. 1 is a schematic view of a measuring device comprising an active measuring functional unit 1, a transducer 5 and a passive device 2 in the form of a cuvette 3 including the lamp 4 for signalling, the passive device being located here outside the electromagnetic radiation (field) used, and

FIG. 2 is a schematic view of said passive device 2 in the form of a cuvette 3 located inside the electromagnetic radiation used between the active measuring functional unit 1 and the passive device 2 such that the passive device is active.

If an active measuring functional unit 1 comprising a transducer 5 is to be calibrated in the field, i.e. in the field of application, a reference medium has to be provided on the sensitive part and therefore on the transducer 5. In the transducer 5 for dissolved oxygen, this can be done by means of a cuvette 3, for example, which is filled with a corresponding calibration solution, or, in the case of fluorescence optical sensors for pO2/dissolved oxygen, with a calibration gas. The calibration medium in the form of a solution or gas can also be provided by a sponge impregnated therewith or as part of a flow (gas cuvette).

A cuvette 3 of this type has to be handled according to specific requirements, this most often requiring said cuvette to be directly mounted on or around the transducer 5 and the initiation of the calibration/adjustment function on the measuring device, usually at the cable end of the active measuring functional unit 1, i.e. remote from the transducer 5 that is subjected to the reference conditions. In the use example, the transducer, mounted on the measuring functional unit 1 in this case, can also be inserted into the cuvette 3 in order to achieve the reference conditions. The calibration function is advantageously triggered by means of the passive device 2 of the cuvette 3. This can be a component of the cuvette 3 or is a separate device arranged on the cuvette 3. The passive device 2 contains a data-processing system in conjunction with the transceiver unit for electromagnetic radiation. For this purpose, the transceiver unit consists of a known transmitter and receiver or a combination of a transmitter and receiver in conjunction with an antenna/coil in each case. The data-processing system of the passive device is connected to at least one lamp 4. Said lamp can be one or more known light-emitting diodes, in particular different-coloured light-emitting diodes. Furthermore, the passive device 2 can be provided with at least one additional sensor element, which is connected to the data-processing system of the passive device. The sensor element can be a temperature or pressure sensor.

In order to be calibrated using the cuvette 3, the transducer 5 mounted on the active measuring functional unit 1 is in contact with the medium. For this purpose, the passive device 2 can be formed as a cap or tube section. After assembly, the cuvette is detected by the active measuring functional unit 1 and the connection between the transceiver units of the active measuring functional unit 1 and of the passive device 2 is established. The operational readiness of the passive device 2, created by the electromagnetic radiation, is displayed by means of the lamp 4. In the simplest case, the operational readiness simultaneously causes the active measuring functional unit 1 to start the function of calibrating the transducer 5 by means of the data-processing system thereof. At the end of said function, a corresponding signal is sent from the active measuring functional unit 1 to the passive device 2, which in turn leads to the actuation of an additional lamp or of the lamp 4. The cuvette 3 can be removed once again or filled with the next reference medium in order to repeat the process.

Said process can therefore be easily controlled on-site. Due to its passive nature, the passive device is constantly ready for use.

In addition to the operating modes, data can of course also be transmitted so that measured data, permissions or specific measurement conditions can be exchanged.

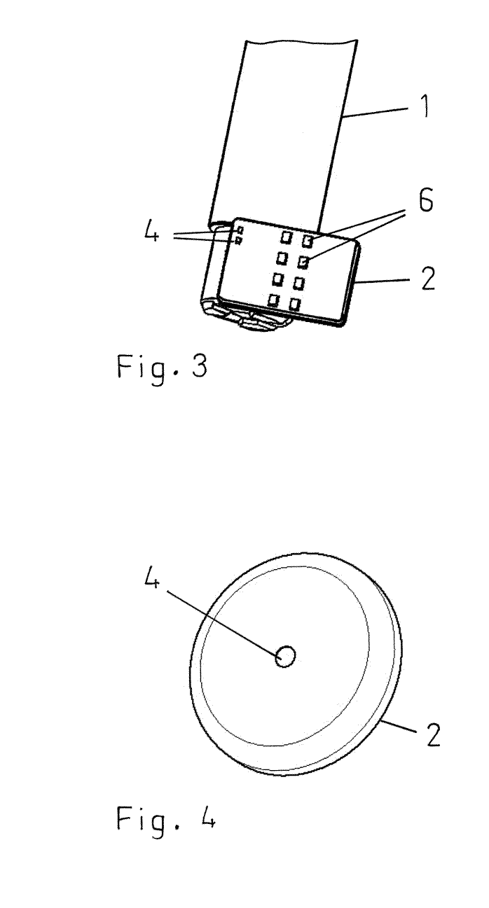

FIG. 3 is a schematic view of a measuring device comprising an active measuring functional unit 1, a transducer 5 and a passive device 2 for controlling the measuring device.

Active measuring functional units 1, which do not have digital, wired communication, but function using analogue interfaces, for example the 4 to 20-mA current loop or with 0 to 5 V DC voltage, are not directly able to modify a measuring condition, for example in the form of a measuring interval, of setting the amplification or of the measured-value filter strength, to start or stop the measurement, or to output status information via said analogue interfaces. The passive device 2 allows such functions to be activated, configured and/or read out. In this case, the active measuring functional unit 1 can operate the transducer 5, for example, at a new measuring interval by means of the passive device 2. This occurs when the passive device 2 enters the coupling range of the transceiver unit of an active measuring functional unit 1. For this purpose, the passive device 2 can also be provided with keys 6 and/or with a screen (e.g. ink display), also in the form of a touchscreen. Keys and a screen are connected to the data-processing system of the passive device such that a specific operating mode of the data-processing system can be triggered or terminated. This operating mode is transmitted to the data-processing system of the active measuring functional unit 1 so that the operating mode of the active measuring functional unit 1 and of the transducer 5 can be changed accordingly. By means of the screen or lamp, the particular operating mode can be controlled and/or influenced. Alternatively to interactive keys, the passive functional unit can also transmit specific configurations automatically such that it is sufficient to bring the two transceiver units in the radio range.

FIG. 4 is a schematic view of a passive device 2 in the form of an information means.

In a third embodiment, the passive device 2 is an information means relating to the status of the measuring device or a combination of the configuration and/or the transfer of commands and the associated status information. Measuring devices or sensors in the form of a subassembly of measuring devices consisting of the active measuring functional unit 1 and at least one transducer 5, often do not comprise integrated indicators. This can be for economic reasons, on account of sealing requirements for the sensors, material problems, measures relating to explosion protection or environmental conditions (for example sensors for use in water in sewage plants, which are submerged in the water). It is also essential that various applications do not to allow permanent access to the sensors, and therefore such indicators are useless.

However, there is often a temporary need to have the status directly displayed on the sensor.

For this purpose, the passive device 2 can advantageously be used. Said device contains an indicator in the form of at least one lamp 4 or a display. For this purpose, the passive device 2 can be formed as a key, in the form of a card, as an armband, as a key ring or as a tag. For this purpose, the lamp can in particular be a multi-coloured light-emitting diode. If the passive unit enters the range of the transceiver unit of the active measuring functional unit 1, the power required for the passive device 2 to operate can be transmitted and communication can be started. In this case, commands or configuration data can be exchanged and/or the status information relating to the data-processing system of the sensor 1 is transmitted to the passive device 2. In this case, the light-emitting diode is switched on via the data-processing system of the passive device 2 such that a colour or flash frequency assigned to the status is emitted.

Such an embodiment of the passive device 2 can advantageously be fixed to the transceiver unit for electromagnetic radiation of the measuring functional device by a magnetic force (for example sintered NdFeb magnets) for continuous use or for the desired coupling time.

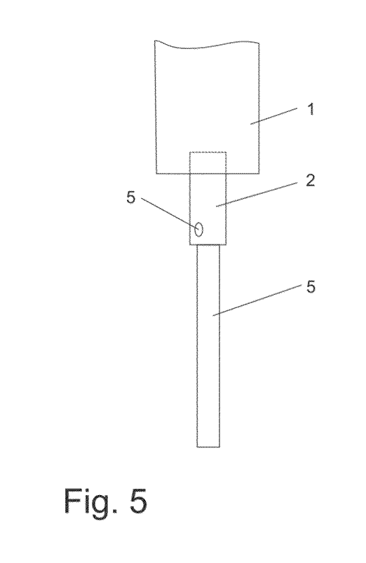

FIG. 5 is a schematic view of a passive device 2 comprising a transducer 5, which is mounted on an active measuring functional unit 1.

In this embodiment, the passive device 2 is formed having a pH electrode, for example, which is connected to the active measuring functional unit 1 in the form of a replaceable element that is not in wired contact therewith and is galvanically isolated therefrom.

Power for the passive device including the transducer 5 is transferred by means of the transceiver units of the active measuring functional unit 1 and of the passive device 2. Communication, i.e. the exchange of data, also takes place via this path.

The electrode, i.e. the transducer 5, together with the associated passive device 2 is thereby robustly connected to the active measuring functional unit 1 so as to be galvanically isolated therefrom and so that it can be replaced.

Additional transducers, for example in the form of temperature sensors, in the passive device 2 can be directly processed by means of the data-processing system in the passive device 2 and thus allow for the reduced transmission of data (measured values) to the active measuring functional unit 1.

As a result of the simultaneous use of a plurality of passive functional units, for example as a result of the use of an additional passive device in the form of a cuvette, calibration in accordance with the representations in FIGS. 1 and 2 and the above-described use example can also take place in this use example.

### LIST OF REFERENCE NUMERALS

1. active measuring functional unit/sensor
2. passive device
3. cuvette
4. lamp
5. transducer
6. key(s)

1. Measuring device for determining physical properties, chemical properties, biological properties and/or substances in the environment of at least one transducer (5) or of the at least one transducer (5) as a component of the measuring device, characterised in that the transducer (5) is a component of an active measuring functional unit (1) and/or of a passive device (2), in that the active measuring functional unit (1) comprises at least one data-processing system and one transceiver unit for electromagnetic radiation, which are interconnected to an electrical power source, and in that the transceiver unit of the active measuring functional unit (1) is wirelessly connected to at least one transceiver unit, for electromagnetic radiation, of at least one passive device (2) that
comprises at least one operating element in conjunction with at least one switch as a component of an electrical circuit,
comprises at least one switch as a component of an electrical circuit,
is designed for controlling the measuring device,
is designed for signalling,
is designed for displaying an operating state,
is designed for transferring measured and/or reference values,
is designed for calibrating the transducer,
is formed as a data medium, and/or
is formed as a data store,
the electromagnetic radiation being electromagnetic radiation that transmits power and either signals and/or data such that at least one passive device (2) in conjunction with at least one active measuring functional unit (1) forms a component of the measuring device.

2. Measuring device according to claim 1, characterised in that the electrical power source is electric mains, an accumulator, a power store, a power converter or a combination thereof.

3. Measuring device according to claim 1, characterised in that the transducer (5) is an electrochemical sensor, a biochemical sensor, an optical sensor, a semiconductor sensor, a solids sensor, a microsystem, an electrode, an optrode, a physical sensor element or a combination thereof.

4. Measuring device according to claim 1, characterised in that the passive device (2) comprises a data-processing system that is connected to the operating element, the switch, the signalling system, the display, the data medium, the data store, a measured value transducer and/or a measuring transmitter.

5. Measuring device according to claim 1, characterised in that the passive device (2) for calibrating the transducer (5) is a calibration cuvette.

6. Measuring device according to claim 1, characterised in that the passive device (2) for calibrating the transducer (5) comprises at least one pressure sensor, one temperature sensor, one pH sensor, one conductivity sensor and/or one moisture sensor in each case.

7. Measuring device according to claim 1, characterised in that the passive device (2) comprising the switch operates as a function-starting or function-ending switch via the data-processing system of the active measuring functional unit (1).

8. Measuring device according to claim 1, characterised in that the passive device (2) in the form of a data store contains data in the form of times, identification data, codes, reference values, actual values, software, a mathematical function, linearisation parameters, calibration parameters and/or an algorithm for influencing the data-processing system of the active measuring functional unit (1).

9. Measuring device according to claim 5, characterised in that the calibration cuvette in the form of a passive device (2) is connected to the active measuring functional unit, the calibration cuvette comprising at least two measured values and/or reference values.

10. Measuring device according to claim 1, characterised in that the data-processing system of the active measuring functional unit (1) and a data-processing system as a component of the passive device (2) are connected to one another by means of the respective transceiver units in order to transmit power and signals and/or data so as to influence the mode of operation of the particular data-processing system.

11. Measuring device according to claim 1, characterised in that the passive device (2) for signalling is a passive device (2) that emits at least one optical and/or at least one acoustic signal.

12. Measuring device according to claim 1, characterised in that the operating element of the passive device (2) is at least one key and/or at least one switch in conjunction with a data-processing system of said passive device (2).

13. Measuring device according to claim 1, characterised in that the passive device (2) comprises at least one sensor element, the passive device (2) being a passive device (2) comprising the at least one sensor element or the sensor element being connected to the data-processing system of the passive device (2).

14. Measuring device according to claim 1, characterised in that the transceiver unit for electromagnetic radiation and the active measuring functional unit (1) are releasably connected to one another, and in that the transceiver unit is interconnected to the active measuring functional unit (1) and to the electrical power source.

15. Measuring device according to claim 1, characterised in that the transceiver unit for electromagnetic radiation, which unit can be connected to the active measuring functional unit (1), is connected to a data medium, a data store and/or an additional data-processing system.
